(19) United States
(12) Patent Application Publication
(10) Pub. No.: US 2025/0208478 A1
(43) Pub. Date: Jun. 26, 2025

(54) OPTICAL PHASED ARRAY, METHOD OF OPERATING THE SAME, AND ELECTRONIC DEVICE INCLUDING THE OPTICAL PHASED ARRAY

(71) Applicant: SAMSUNG ELECTRONICS CO., LTD., Suwon-si (KR)

(72) Inventors: Jisan LEE, Suwon-si (KR); Inoh Hwang, Suwon-si (KR)

(73) Assignee: SAMSUNG ELECTRONICS CO., LTD., Suwon-si (KR)

(21) Appl. No.: 18/770,276

(22) Filed: Jul. 11, 2024

(30) Foreign Application Priority Data
Dec. 26, 2023 (KR) 10-2023-0191857

(51) Int. Cl. G02F 1/29; G01S 7/481

(52) U.S. Cl. CPC G02F 1/292; G01S 7/4817; G02F 2203/11; G02F 2203/50; G02F 2203/70

(57) ABSTRACT

An optical phased array according to an example embodiment includes a light source configured to emit a light in an infrared band; a light irradiator configured to receive the emitted light and irradiate the light to an outside; a phase modulation optical amplification unit provided between the light source and the light irradiator; and an optical splitting configured to split the light emitted from the light source, wherein the phase modulation optical amplification unit is configured to amplify the light emitted from the light source while modulating a first phase of the emitted light to a second phase, and includes: a phase modulator configured to cause a portion of a phase difference between the first phase and the second phase; and a phase modulation optical amplifier configured to amplify the emitted light while causing a remaining portion of the phase difference.

### CROSS-REFERENCE TO RELATED APPLICATION

This application is based on and claims priority under 35 U.S.C. § 119 to Korean Patent Application No. 10-2023-0191857, filed on Dec. 26, 2023, in the Korean Intellectual Property Office, the disclosure of which is incorporated by reference herein in its entirety.

### BACKGROUND

### 1. Field

One or more example embodiments of the disclosure relate to a detection device using light, and more specifically, to an optical phased array, an operating method of the same, and an electronic device including the optical phased array.

### 2. Description of the Related Art

An optical phased array (OPA) refers to a technique of irradiating light in an arbitrary pattern by using the principle of an electromagnetic phased array that outputs electromagnetic waves, which has been mainly used in existing radar technology, and uses optical frequencies instead of electromagnetic waves.

A light detection and ranging (LiDAR), which utilizes existing beam scanning, uses devices such as mechanical motors, rotation motors, and micro electro mechanical systems (MEMs) and has a simple structure. However, productivity and manufacturing costs are problematic. On the other hand, an OPA LiDAR device enables precise and fast control because non-mechanical beam scanning is used and has been attracting attention recently because it may be manufactured by utilizing existing semiconductor processes, and the manufacturing costs are significantly reduced through mass production.

### SUMMARY

One or more example embodiments provide an optical phased array with increased beamforming efficiency in a region of interest.

One or more example embodiments provide an optical phased array with increased light intensity in a region of interest.

One or more example embodiments provide a method of operating an optical phased array.

One or more example embodiments provide an electronic device including the optical phased array.

Additional aspects will be set forth in part in the description which follows and, in part, will be apparent from the description, or may be learned by practice of the presented embodiments of the disclosure

According to an aspect of an example embodiment of the disclosure, an optical phased array includes a light source configured to emit a light in an infrared band; a light irradiator spaced apart from the light source and configured to receive the light emitted from the light source and emit the light to an outside; a phase modulation optical amplification unit provided between the light source and the light irradiator; and an optical splitting portion disposed between the light source and the phase modulation optical amplification unit and configured to split the light emitted from the light source, the optical splitting portion including a plurality of optical splitters, wherein the phase modulation optical amplification unit is configured to amplify the light emitted from the light source while modulating a first phase of the emitted light to a second phase which is a target phase, and includes: a phase modulator configured to cause a portion of a phase difference between the first phase and the second phase; and a phase modulation optical amplifier configured to amplify the emitted light while causing a remaining portion of the phase difference.

In one example, the phase modulator and the phase modulation optical amplifier may be aligned in an order named in a direction from the light source to the light irradiator.

In one example, the phase modulation optical amplifier and the phase modulator may be aligned in an order named in the direction from the light source to the light irradiator.

In one example, an optical amplifier may be disposed between at least one optical splitter of the plurality of optical splitters and another at least one optical splitter of the plurality of optical splitters. In one example, the phase modulation optical amplification unit may include a plurality of the phase modulation optical amplification units spaced apart from each other, and one optical splitter among the plurality of optical splitters may be arranged to split the light to be provided to two optical splitters in a next stage among the plurality of optical splitters. In one example, two to four optical amplifiers may be disposed between a portion of the plurality of optical splitters and a remaining portion of the plurality of optical splitters.

In one example, the phase modulation optical amplifier may include a semiconductor optical amplifier (SOA).

In one example, the light source may include a laser diode configured to emit an infrared light and a semiconductor optical amplifier (SOA) configured to amplify the infrared light.

In one example, the light irradiator, the phase modulation optical amplification unit, and the optical splitting portion may be provided in one single chip, and the light source is coupled to the one single chip. In one example, the light source may be bonded to the one single chip using a flip chip method.

In one example, the phase modulation optical amplification unit may include a plurality of phase modulation optical amplification units, and the plurality of phase modulation optical amplification units may have different optical amplification rates from each other.

In one example, the light irradiator may include an antenna array, the antenna array including a plurality of antenna elements or a mirror type emitting element.

According to another aspect of the disclosure, a light detection and ranging (LiDAR) includes a light source unit configured to emit a light toward an object, wherein the light source unit includes the optical phased array described above; a receiver configured to receive a light reflected from the object and generate an electrical signal in response to the received light; a processor configured to process the electrical signal transmitted from the receiver; and a controller configured to control an operation of the light source unit, the receiver, and/or the processor.

According to an aspect of an example embodiment the disclosure, an electronic device includes the optical phased array according to an example embodiment or the LiDAR according to an example embodiment.

According to an aspect of an example embodiment of the disclosure, a method of operating an optical phased array includes performing a first beamforming on a first region of interest by applying currents of different magnitudes to the plurality of phase modulation optical amplifiers.

In one example, during the first beamforming, a voltage applied to each of the plurality of phase modulators is maintained constant at a same level of magnitude.

In one example, the method may further include: after performing the first beamforming, performing a second beamforming on the first region of interest by applying different voltages to the plurality of phase modulator.

In one example, the method may further include, after a third beamforming, including the first beamforming, for the first region of interest is completed, creating a lookup table for beam steering of the plurality of phase modulators and the plurality of phase modulation optical amplifiers based on voltage data applied to the plurality of phase modulators and current data applied to the plurality of phase modulation optical amplifiers for the third beamforming.

In one example, the method may further include, after performing the second beamforming, acquiring a beam image formed in the first region of interest by a third beamforming, and acquiring a beam profile from the beam image. In one example, the beam image may be acquired using an infrared camera provided outside an optical phased array chip on which the plurality of phase modulation optical amplification units are provided or a detector formed within the optical phased array chip.

### BRIEF DESCRIPTION OF THE DRAWINGS

The above and other aspects, features, and advantages of certain example embodiments of the disclosure will be more apparent from the following description taken in conjunction with the accompanying drawings, in which:

FIGS. 1 to 5 are block diagrams showing a first optical phased array (OPA) to a fifth OPA according to example embodiments;

FIG. 6 shows a third OPA in a simplified configuration to explain an operation method of the third OPA according to an example embodiment;

FIG. 7 is a flowchart showing an operation method of an OPA according to an example embodiment;

FIG. 8 is a flowchart illustrating an operation method of an OPA according to an example embodiment that was applied in a simulation;

FIGS. 9A, 9B, 10A, and 10B are graphs showing simulation results for an OPA operation method according to example embodiments and simulation results of comparative methods;

FIG. 11 is a block diagram showing a first electronic device (e.g., light detection and ranging (LIDAR)) according to an example embodiment; and

FIG. 12 is a block diagram showing a second electronic device according to an example embodiment.

### DETAILED DESCRIPTION

Reference will now be made in detail to embodiments, examples of which are illustrated in the accompanying drawings, wherein like reference numerals refer to like elements throughout. In this regard, the example embodiments may have different forms and should not be construed as being limited to the descriptions set forth herein. Accordingly, the example embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, an optical phased array, an operating method thereof, and an electronic device including the optical phased array according to one or more example embodiments will be described in detail with reference to the accompanying drawings. In the drawings, thicknesses of layers and regions may be exaggerated for clarification of the specification.

The following embodiments described below are merely illustrative, and various modifications may be possible from the embodiments of the disclosure. When an element or layer is referred to as being “on” or “above” another element or layer, the element or layer may be directly on another element or layer or intervening elements or layers. In the descriptions below, like reference numerals in the drawings refer to like elements.

The singular forms are intended to include the plural forms as well, unless the context clearly indicates otherwise. When a part “comprises” or “includes” an element in the specification, unless otherwise defined, it is not excluding other elements but may further include other elements.

The term “above” and similar directional terms may be applied to both singular and plural. With respect to operations that constitute a method, the operations may be performed in any appropriate sequence unless the sequence of operations is clearly described or unless the context clearly indicates otherwise. The operations may not necessarily be performed in the order of sequence.

Also, in the specification, the term “units” or “ . . . modules” denote units or modules that process at least one function or operation, and may be realized by hardware, software, or a combination of hardware and software.

The connections of lines and connection members between constituent elements depicted in the drawings are examples of functional connection and/or physical or circuitry connections, and thus, in practical devices, may be expressed as replaceable or additional functional connections, physical connections, or circuitry connections.

The use of all examples or illustrative terms is simply for explaining the technical idea in detail, and the scope is not limited by the examples or illustrative terms unless limited by the claims.

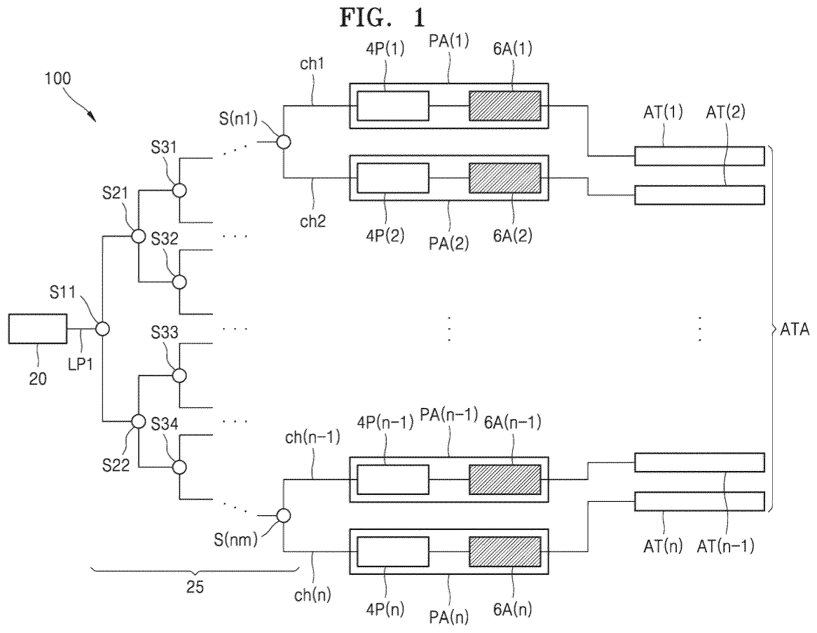

FIG. 1 is a block diagram showing a first optical phased array (OPA) 100 according to an example embodiment.

Referring to FIG. 1, the first OPA 100 may include a light source 20 and an antenna array ATA. The light source 20 and the antenna array ATA may be spaced apart from each other. A plurality of elements may be provided between the light source 20 and the antenna array ATA. The light source 20 may include a light emitting element or a light emitting device that emits light for beam scanning of an OPA. In one example, the light source 20 may include a light source that emits laser light in a single wavelength in a form of a continuous wave or pulse wave. In one example, the light source 20 may include a light source (e.g., a tunable laser diode) that emits tunable laser light in the form of a continuous wave or pulse wave. In one example, light emitted from the light source 20 may include laser light. As an example, the light source 20 may emit laser light in an infrared band but is not limited thereto. In one example, light emitted from the light source 20 may include light irradiated to an object in order to recognize the object and/or obtain information about the object.

In one example, the light source 20 may be provided with an amplifier therein to amplify infrared rays emitted from the light source 20 or may not be provided with the amplifier. In one example, the light source 20 may include, but is not limited to, a ring-resonator type tunable laser including two optical amplifiers. In one example, the optical amplifier may include, but is not limited to, a semiconductor optical amplifier (SOA). The light source 20 may be referred to as a light source, a light-emitting unit, a light source unit, a light-releasing unit, etc.

In one example, a plurality of channels ch1, ch2 . . . ch(n−1), . . . ch(n) connecting the light source 20 to the antenna array ATA may be provided between the light source 20 and the antenna array ATA. The plurality of channels ch1, ch2, . . . ch(n−1), ch(n) may be optical transmission paths or optical transmission media through which light emitted from the light source 20 is transmitted to the antenna array ATA. Therefore, the plurality of channels ch1, ch2, . . . ch(n−1), ch(n) may be referred to as optical transmission channels or optical signal transmission channels. The plurality of channels ch1, ch2, . . . ch(n−1), ch(n) may be a result of division in which a first light transmission medium LP1 directly connected to the light source 20 is divided into multiple lines through a plurality of division steps performed along with a direction from the light source 20 to the antenna array ATA. In one example, the first light transmission medium LP1 may be a medium for transmitting light emitted from the light source 20 to the antenna array ATA. For example, the first light transmission medium LP1 may include, but is not limited to, a waveguide or an optical fiber.

In one example, the first light transmission medium LP1 may be divided into two at each step of the plurality of division stages, and optical splitters S11, S21, S22, S31-S34, . . . S(n1)-S(nm) may be provided at a branch point of each division stage.

Light input to each optical splitter S11, S21, S22, S31-S34, . . . S(n1)-S(nm) may be split into two pieces of light having the same wavelength and phase as the input light. The split light may propagate along a path divided into two in each optical splitter S11, S21, S22, S31-S34, . . . S(n1)-S(nm). A plurality of phase modulation optical amplification units PA(1), PA(2), . . . PA(n−1), PA(n) may be provided between the light source 20 and the antenna array ATA. The number n of the plurality of phase modulation optical amplification units PA(1), PA(2), . . . PA(n−1), PA(n) may be the same as the number of channels ch1, ch2, . . . ch(n−1), ch(n) of the first OPA 100. That is, one phase modulation optical amplifier may be disposed for each channel ch1, ch2, . . . ch(n−1), ch(n).

Each of the phase modulation optical amplification units PA(1), PA(2), . . . PA(n−1), PA(n) may modulate the phase of light input (transmitted) through the corresponding channel and may be provided to amply light. In one example, each of the phase modulation optical amplification units PA(1), PA(2), . . . PA(n−1), PA(n) may include elements for phase modulation and amplification of input (transmitted) light. However, the phase modulation and amplification of the light may also be performed with one single element. The phase of the light before being incident on the plurality of phase modulation optical amplification units PA(1), PA(2), . . . PA(n−1), PA(n) may all be the same or different at the each channel ch1, ch2, . . . ch(n−1), ch(n), and the intensity of the light may all be the same or different.

In one example, each of the phase modulation optical amplification units PA(1), PA(2), . . . PA(n−1), PA(n) may include one phase modulator and one phase modulation optical amplifier. For example, a first phase modulation optical amplification unit PA(1) may include one first phase modulator 4P(1) and one first phase modulation optical amplifier 6A(1). An n-th phase modulation optical amplification unit PA(n) may include one n-th phase modulator 4P(n) and one n-th phase modulation optical amplifier 6A(n). In the phase modulation optical amplification units PA(1), PA(2), . . . PA(n−1), PA(n), the phase modulators 4P(1), 4P(2), . . . 4P(n−1), 4Pn) and the phase modulation optical amplifiers 6A(1), 6A(2), . . . 6A(n−1), 6A(n) may be respectively connected to a light transmission medium or a light transmission element that does not affect the phase of light.

As a result, the number of the plurality of phase modulators 4P(1), 4P(2), . . . 4P(n−1), 4P(n) in the first OPA 100 may be equal to the number of the plurality of phase modulation optical amplification units PA(1), PA(2), . . . PA(n−1), PA(n). The number of phase modulation optical amplifiers 6A(1), 6A(2), . . . 6A(n−1), 6A(n) and the number of the plurality of phase modulation optical amplification units PA(1), PA(2), . . . PA(n−1), PA(n) may be the same.

Each of phase modulation optical amplification units PA(1), PA(2), . . . PA(n−1), PA(n) may be configured to amplify the light emitted from the light source while modulating a first phase of the emitted light to a second phase which is a target phase. To this end, each of phase modulators 4P(1), 4P(2), . . . 4P(n−1), 4P(n) may be configured to cause a portion of a phase difference between the first phase and the second phase (which may be referred to as a primary phase modulation), and each of phase modulation optical amplifiers 6A(1), 6A(2), . . . 6A(n−1), 6A(n) may be configured to amplify the emitted light while causing a remaining portion of the phase difference (which may be referred to as a secondary phase modulation).

In one example, the primary phase modulation with respect to incident light may be performed at each phase modulator 4P(1), 4P(2), . . . 4P(n−1), 4P(n). The secondary phase modulation (also may referred to as a secondary phase modulation and optical amplification) may be achieved in each phase modulation optical amplifier 6A(1), 6A(2), . . . 6A(n−1), 6A(n). The primary phase modulation may also be expressed as main phase modulation. The secondary phase modulation may be expressed as auxiliary phase modulation. If the secondary phase modulation is greater than the primary phase modulation, they may be expressed in reverse (e.g., the secondary phase modulation may be expressed as the main phase modulation). In one example, an amount (or degree) of the primary phase modulation may be greater than an amount of the secondary phase modulation but is not limited thereto. In one example, a sum of the primary phase modulation and the secondary phase modulation may be a phase modulation amount or phase modulation value of each of the phase modulation optical amplification units PA(1), PA(2), . . . PA(n−1), PA(n). The optical amplification performed by each of the phase modulation optical amplifiers 6A(1), 6A(2), . . . 6A(n−1), 6A(n) may be the optical amplification performed by each of the phase modulation optical amplification units PA(1), PA(2), . . . PA(n−1), PA(n). In one example, each phase modulation optical amplifier 6A(1), 6A(2), . . . 6A(n−1), 6A(n) may include an amplification element, for example, a semiconductor optical amplifier (SOA), in which phase modulation occurs when a current for optical amplification is applied. In one example, if the light transmitted from the light source 20 is laser light in the form of a continuous wave or pulse, each phase modulation optical amplifier 6A(1), 6A(2), . . . 6A(n−1), 6A(n) may also be driven according to the type of transmitted light.

In a beam steering, the amount of phase modulation and the degree of optical amplification of each of the phase modulation optical amplification units PA(1), PA(2), . . . PA(n−1), PA(n) may be controlled based on a lookup table (LUT) created through a beamforming process of the first OPA 100.

The amount of phase modulation and the degree of optical amplification of each of the phase modulation optical amplification units PA(1), PA(2), . . . PA(n−1), PA(n) may vary depending on an area to which a light beam (e.g., infrared laser light or infrared light) is irradiated, the irradiation angle, and/or irradiation direction of the light beam.

For example, if a light beam is irradiated to an area of interest or a first area from the antenna array ATA of the first OPA 100 on a set horizontal plane, a phase of first light incident on the first phase modulation optical amplification unit PA(1) may be changed by a first value, light intensity of the first light may be increased by a second value, and a phase of second light incident on a second phase modulation optical amplification unit PA(2) may be changed by a third value, and light intensity of the second light may be increased by a fourth value. In one example, the first and third values may be the same as or different from each other, and the second and fourth values may also be the same or different from each other. The first and second lights may be the same from each other in wavelength and intensity.

For such phase modulation and optical amplification, a first voltage may be applied to a first phase modulator 4P(1) of the first phase modulation optical amplification unit PA(1) and a first current may be applied to the first modulation amplifier 6A(1) according to the lookup table. And, a second voltage may be applied to a second phase modulator 4P(2) of the second phase modulation optical amplification unit PA(2), and a second current may be applied to the second phase modulation optical amplifier 6A(2). In one example, the magnitude of the first voltage and the magnitude of the second voltage may be the same or different from each other, and the amount of the first current and the amount of the second current may be the same or different from each other. For example, the magnitudes of the first and second voltages may be the same, and the amounts of the first and second currents may be different from each other. For example, the magnitudes of the first and second voltages may be different from each other, and the amounts of the first and second currents may be the same. For example, the magnitudes of the first and second voltages may be different from each other, and the amounts of the first and second currents may be different from each other.

If a light beam is irradiated to the area of interest or the first area, as in the case of the first and second phase modulation optical amplification units PA(1) and PA(2), the phase modulation amounts of the third to nth phase modulation optical amplification units PA(3), . . . PA(n−1), PA(n) may be the same, different from each other, or at least partially different from each other. The degrees of optical amplification of the third to nth phase modulation optical amplification units PA(3), . . . PA(n−1), PA(n) may be the same, different, or at least partially different from each other.

The plurality of phase modulation optical amplification units PA(1), PA(2), . . . PA(n−1), PA(n) may be directly or indirectly connected to the antenna array ATA. This connection may be achieved through a light transmission medium (element) (e.g., waveguide, optical fiber, etc.) but is not limited thereto.

In each of the phase modulation optical amplification units PA(1), PA(2), . . . PA(n−1), PA(n), the phase modulators 4P(1), 4P(2), . . . 4P(n−1), 4P(n) and the phase modulation optical amplifiers 6A(1), 6A(2), . . . 6A(n−1), and 6A(n) may be aligned in a direction from the light source 20 towards the antenna array ATA. Each of the phase modulation optical amplifier 6A(1), 6A(2), 6A(n−1), . . . 6A(n) may be connected to the antenna array ATA through the light transmission medium. In each of the phase modulation optical amplification units PA(1), PA(2), . . . PA(n−1), PA(n), the phase modulators 4P(1), 4P(2), . . . 4P(n−1), 4P(n) may be spaced apart from the plurality of phase modulation optical amplification units PA(1), PA(2), . . . PA(n−1), PA(n). The phase modulators 4P(1), 4P(2), . . . 4P(n−1), 4P(n) and the plurality of phase modulation optical amplification units PA(1), PA(2), . . . PA(n−1), PA(n) may be connected through a light transmission medium.

The antenna array ATA may include a plurality of antenna elements AT(1), AT(2), . . . AT(n−1), AT(n) that may radiate (or irradiate) light (e.g., infrared laser or infrared light) into a space outside the antenna array ATA. The number of the antenna elements AT(1), AT(2), . . . AT(n−1), AT(n) may be the same as the number of the plurality of phase modulation optical amplification units PA(1), PA(2), . . . PA(n−1), PA(n). In one example, the plurality of antenna elements AT(1), AT(2), . . . AT(n−1), AT(n) and the plurality of phase modulation optical amplification units PA(1), PA(2), . . . PA(n−1), PA(n) may be connected to each other to one-to-one correspondence. In other words, the phase modulation optical amplifiers 6A(1), 6A(2), . . . 6A(n−1), 6A(n) of each phase modulation optical amplification unit PA(1), PA(2) . . . PA(n−1), PA(n) and each antenna element AT(1), AT(2), . . . AT(n−1), AT(n) may correspond one-to-one. Each phase modulation optical amplifier 6A(1), 6A(2), . . . 6A(n−1), 6A(n) and each antenna element AT(1), AT(2), . . . AT(n−1), AT(n) may be connected to each other through a light transmission medium.

In one example, the plurality of antenna arrays ATA and the plurality of phase modulation optical amplification units PA(1), PA(2), . . . PA(n−1), PA(n) may be provided in the same chip (e.g., an optical phased array chip) and may be arranged parallel to each other.

In one example, each antenna element AT(1), AT(2), . . . AT(n−1), AT(n) may include a grating antenna including a diffraction grating but is not limited thereto.

In one example, each antenna element AT(1), AT(2), . . . AT(n−1), AT(n) may be replaced by a non-antenna element, for example, may be replaced with a mirror type surface emitting or edge emitting element, but is not limited thereto. Because the antenna array ATA and the non-antenna elements are all elements that irradiate transmitted light to the outside of the OPA, they may be expressed as a light irradiation unit (or light irradiator). An optical splitting portion 25 may be provided between the plurality of phase modulation optical amplification units PA(1), PA(2), . . . PA(n−1), PA(n) and the light source 20 to split transmitted light. The optical splitting portion 25 may include the plurality of optical splitters S11, S21, S22, S31-S34, . . . S(n1)-S(nm) arranged in a certain shape (structure) and spaced apart from each other. The plurality of optical splitters S11, S21, S22, S31-S34, . . . S(n1)-S(nm) and the plurality of phase modulation optical amplification units PA(1), PA(2), . . . PA(n−1), PA(n) may be provided in the same chip. The plurality of optical splitters S11, S21, S22, S31-S34 . . . S(n1)-S(nm) may be connected to each other by a light (e.g., infrared laser or infrared light) transmission medium, such as a waveguide or optical fiber, but the light transmission medium is not limited thereto. The optical splitters S11, S21, S22, S31-S34, . . . S(n1)-S(nm) may be arranged in a structure in which the number of the optical splitters S11, S21, S22, S31-S34, . . . S(n1)-S(nm) gradually increases in a direction from the light source 20 towards the antenna array ATA. For example, the first optical splitter S11 may be connected to the light source 20, a channel is divided into two at the first optical splitter S11, the second optical splitter S21 and the third optical splitter S22 may be provided at an end portion of the two divided channels, respectively, each of the divided channels may be again divided into two in each of the second and third optical splitters S21 and S22, and the fourth to seventh optical splitters S31, S32, S33, and S34 may be connected to each divided channel. In this way, as a number of an arrangement stage of the optical splitters increases, a number of an arrangement of the optical splitters may be doubled. For example, the number of the optical splitters may increase from 1 (1st stage), 2 (2nd stage), 4 (3rd stage), 8 (4th stage), 16 (5th stage), 32 (6th stage), and 64 (7th stage) . . . as the number of the arrangement stage of the optical splitters increases.

The light source 20 and the first optical splitter S11 may be directly or indirectly connected to each other. In one example, the light source 20 and the first optical splitter S11 may be connected to an optical transmission medium or optical transmission element capable of transmitting light (e.g., infrared laser or infrared light) emitted from the light source 20 to the first optical splitter S11. In one example, the optical transmission medium may include, but is not limited to, a waveguide or an optical fiber.

In one example, the light source 20 and the first optical splitter S11 may be provided in the same chip. For example, the light source 20 may be provided in the same chip together with the plurality of optical splitters S11, S21, S22, S31-S34, . . . S(n1)-S(nm), the plurality of phase modulation amplification units PA(1), PA(2), . . . PA(n−1), PA(n), and the antenna array ATA. In one example, the light source 20 may include a Group III-V compound semiconductor laser emitting device formed directly within the chip, and may be formed by an epitaxy method.

In one example, the light source 20 may be manufactured outside the chip and coupled to the chip. For example, the light source 20 may be bonded to the chip using a flip chip method.

The first optical splitter S11 may be an optical splitter disposed at a first end of the plurality of optical splitters S11, S21, S22, S31-S34, . . . S(n1)-S(nm). The second and third optical splitters S21 and S22 may be optical splitters disposed at a second stage. The fourth to seventh optical splitters S31 to S34 may be optical splitters arranged in the third stage. The plurality of optical splitters S(n1)-S(nm) disposed immediately before the plurality of phase modulation optical amplification units PA(1), PA(2), . . . PA(n−1), PA(n)) may be optical splitters arranged at the nth stage.

In the nth optical splitter S(nm), ‘n’ represents the number of stages where optical splitters are placed, and ‘m’ represents the number of optical splitters arranged at the nth stage. ‘n’ and ‘m’ are 1, 2, 3 . . . .

Two channels may be branched from one optical splitter, and the number n of the plurality of phase modulation optical amplification units PA(1), PA(2), . . . PA(n−1), PA(n) may be equal to the number of the plurality of channels ch1, ch2, . . . ch(n−1), ch(n). Therefore, the number of the optical splitter S(n1)-S(nm) disposed immediately in front of the plurality of phase modulation optical amplification units PA(1), PA(2), . . . PA(n−1), PA(n) may be ½ of the number of the plurality of phase modulation optical amplification units PA(1), PA(2), . . . PA(n−1), PA(n). That is, m=n/2 or m is ½ of the number of channels of the first OPA 100. For example, if the number of channels of the first OPA 100 is 64, the number of phase modulation optical amplification units PA(1), PA(2), . . . PA(n−1), PA(n) is 64 (n=64), and the number of the optical splitters S(n1)-S(nm) arranged immediately in front of the plurality of phase modulation optical amplification units PA(1), PA(2), . . . PA(n−1), PA(n) is 32 (m=32).

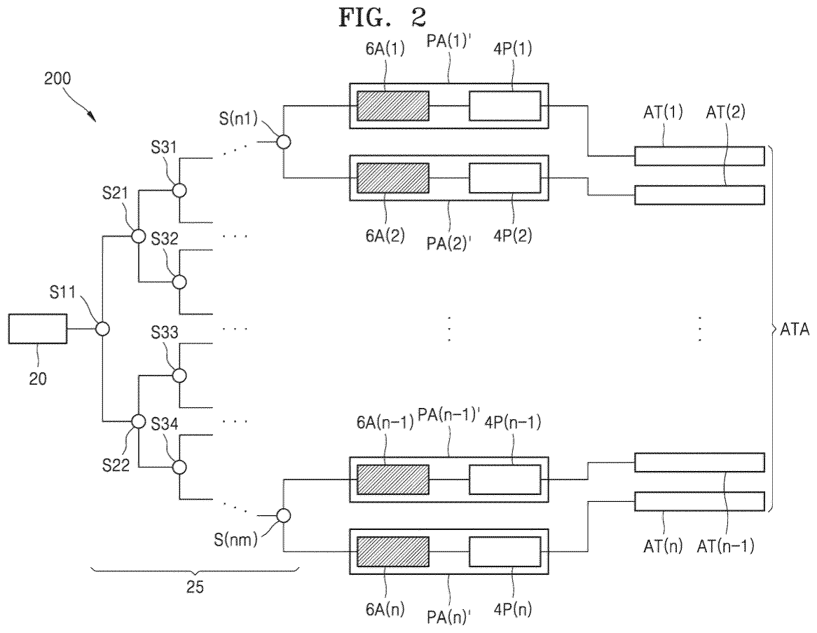

FIG. 2 shows a second OPA 200 according to an example embodiment.

Only parts that are different from the first OPA 100 of FIG. 1 will be described for brevity of explanation.

Referring to FIG. 2, the second OPA 200 may include a plurality of phase modulation optical amplification units PA(1)′, PA(2)′, . . . PA(n−1)′, PA(n)′ at positions as arranged in the first OPA 100, and each of the phase modulation optical amplification units PA(1)′, PA(2)′, . . . PA(n−1)′, PA(n)′ my include one phase modulator and one phase modulation optical amplifier. However, in each of the phase modulation optical amplification units PA(1)′, PA(2)′, . . . , PA(n−1)′, PA(n)′ of the second OPA 200, the alignment order of the phase modulator 4P(1), 4P(2), . . . 4P(n−1), 4P(n) and the phase modulation optical amplifier 6A(1), 6A(2), . . . 6A(n−1), 6A(n) may be opposite to that of the first OPA 100. That is, in each of the phase modulation optical amplification units PA(1)′, PA(2)′, . . . , PA(n−1)′, PA(n)′ of the second OPA 200, the phase modulation optical amplifier 6A(1), 6A(2), . . . , 6A(n−1), 6A(n) and the phase modulator 4P(1), 4P(2), . . . 4P(n−1), 4P(n) may be sequentially arranged in a direction from the light source 20 towards the antenna array ATA. Therefore, in the case of the second OPA 200, in each of the phase modulation optical amplification units PA(1)′, PA(2)′, . . . PA(n−1)′, PA(n)′, the phase modulator 4P(1), 4P(2), . . . 4P(n−1), 4P(n) may be connected to the antenna elements AT(1), AT(2), . . . AT(n−1), AT(n), and the phase modulation optical amplifier 6A(1), 6A(2), . . . 6A(n−1), 6A(n) may be connected to the optical splitter S(n1)-S(nm) arranged immediately in front of each of the phase modulation optical amplification units PA(1)′, PA(2)′ . . . PA(n−1)′, PA(n)′. That is, in the second OPA 200, the plurality of phase modulators 4P(1), 4P(2), . . . 4P(n−1), 4P(n) may be arranged between the plurality of phase modulation optical amplifiers 6A(1), 6A(2), . . . 6A(n−1), 6A(n) and the antenna array ATA.

Accordingly, in the case of the second OPA 200, light amplification and first phase modulation (or primary phase modulation) may be performed first, and then second phase modulation (or secondary phase modulation) of the amplified light may be performed.

For the optical amplification and phase modulation, the principle of applying a voltage and a current to each of the phase modulation optical amplification units PA(1)′, PA(2)′ . . . PA(n−1)′, PA(n)′, that is, an operation method of the phase modulation optical amplification units PA(1)′, PA(2)′ . . . PA(n−1)′, PA(n)′ may be the same the description given with reference to the first OPA 100.

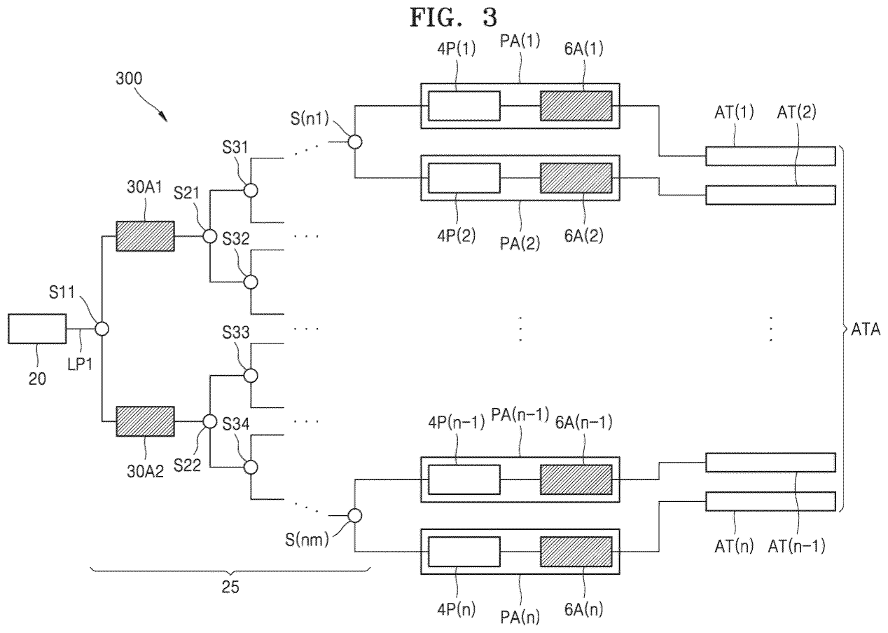

FIG. 3 shows a third OPA 300 according to an example embodiment.

Only parts that are different from the first OPA 100 of FIG. 1 will be described for brevity of explanation.

Referring to FIG. 3, the third OPA 300 may include a first optical amplifier 30A1 disposed between the first optical splitter S11, disposed at the first stage, and the second optical splitter S21, disposed at the second stage, and a second optical amplifier 30A2 disposed between the first optical splitter S11 and the third optical splitter S22, disposed at the second stage. Light split by the first optical splitter S11 may be incident on the first and second optical amplifiers 30A1 and 30A2, and the intensity and phase of the light incident on the first and second optical amplifiers 30A1 and 30A2 may be the same. The first and second optical amplifiers 30A1 and 30A2 may include an optical amplification element or device to amplify the intensity of incident light. In one example, the first and second optical amplifiers 30A1 and 30A2 may include, but are not limited to, semiconductor optical amplifiers.

In one example, the first and second optical amplifiers 30A1 and 30A2 may include optical amplifiers of the same configuration but may also include optical amplifiers of different configurations. The first optical amplifier 30A1 and the first and second optical splitters S11 and S21 may be connected through an optical transmission medium. The second optical amplifier 30A2 and the first and third optical splitters S11 and S22 may also be connected through an optical transmission medium.

In one example, in each of the phase modulation optical amplification units PA(1), PA(2), . . . PA(n−1), P(n), the positions of the phase modulator 4P(1), 4P(2), . . . 4P(n).−1), 4P(n) and the positions of the phase modulation optical amplifiers 6A(1), 6A(2), . . . 6A(n−1), 6A(n) may be exchanged. In other words, the phase modulator 4P(1), 4P(2), . . . 4P(n−1), 4P(n) may be arranged between the phase modulation optical amplifier 6A(1), 6A(2), . . . 6A(n−1), 6A(n) and the antenna array ATA.

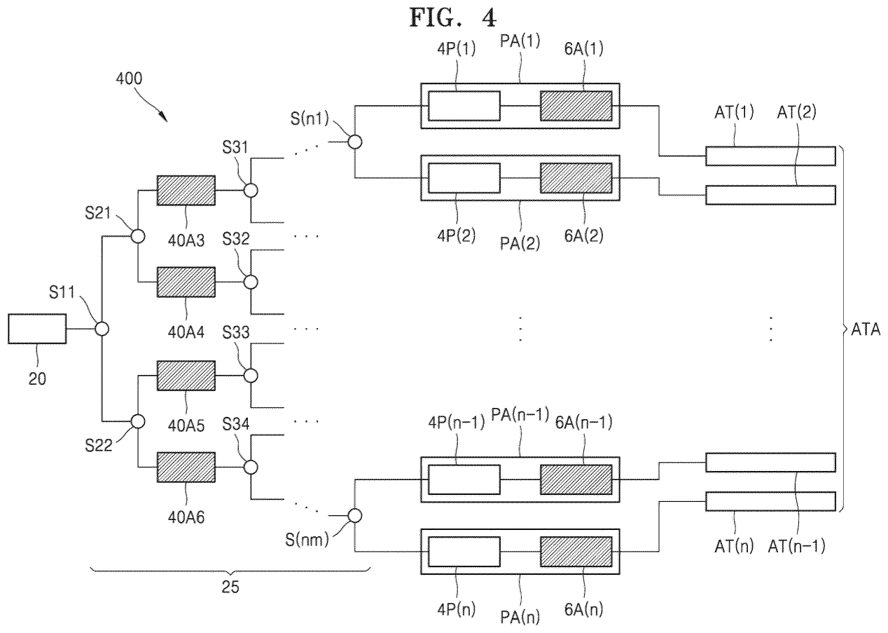

FIG. 4 shows a fourth OPA 400 according to an example embodiment.

Only parts that are different from the third OPA 300 of FIG. 3 will be described for brevity of explanation.

Referring to FIG. 4, like the third OPA 300, the fourth OPA 400 may include a plurality of optical amplifiers 40A3 to 40A6 between the first optical splitter S11 and the plurality of phase modulation optical amplification units PA(1), PA(2), . . . PA(n−1), PA(n). However, while the third OPA 300 may include the first and second optical amplifiers 30A1 and 30A2 between the first optical splitter S11 arranged in the first stage and the second and third optical splitters S21 and S22 arranged in the second stage, the fourth OPA 400 may include third to sixth optical amplifiers 40A3 to 40A6 between the optical splitters S21 and S22 arranged in the second stage and the optical splitters S31 to S34 arranged in the third stage. The third optical amplifier 40A3 may be disposed between the second optical splitter S21 and the fourth optical splitter S31, and the fourth optical amplifier 40A4 may be disposed between the second optical splitter S21 and the fifth optical splitter S32. The fifth optical amplifier 40A5 may be disposed between the third optical splitter S22 and the sixth optical splitter S33, and the sixth optical amplifier 40A6 may be disposed between the third optical splitter S22 and the seventh optical splitter S34. The third to sixth optical amplifiers 40A3 to 40A6 and the adjacent optical splitters S21, S22, and S31 to S34 may be connected through an optical transmission medium. The configuration or structure of the third to sixth optical amplifiers 40A3 to 40A6 may be the same but may also be different. In one example, the third to sixth optical amplifiers 40A3 to 40A6 may include the same optical amplification elements or optical amplification devices as those included in the first and second optical amplifiers 30A1 and 30A2 of the third OPA 300, but it is not limited thereto.

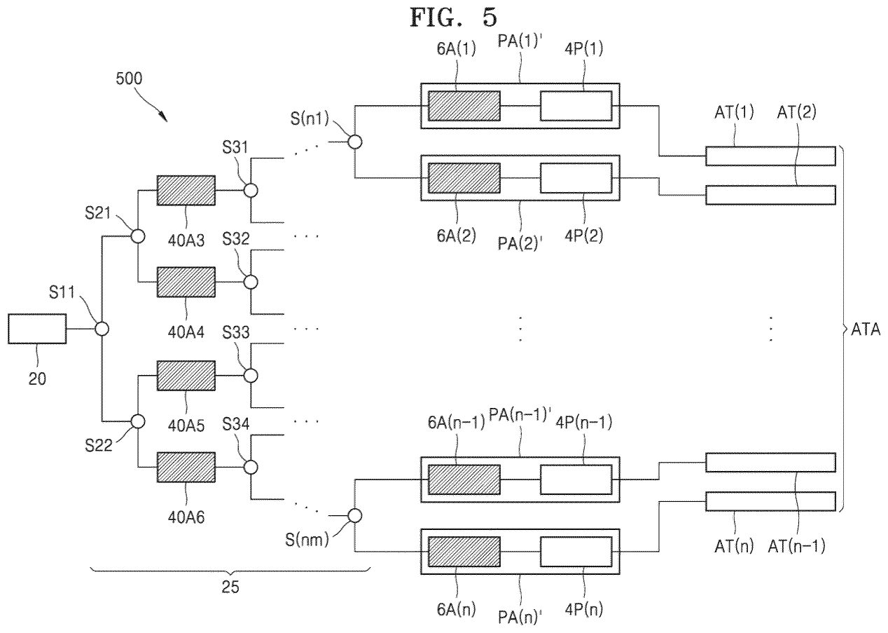

FIG. 5 shows a fifth OPA 500 according to an example embodiment. Only parts that are different from the fourth OPA 400 in FIG. 4 will be described for brevity of explanation.

Comparing FIGS. 4 and 5, the fifth OPA 500 corresponds to a case in which positions of the phase modulators 4P(1), 4P(2), . . . 4P(n−1), 4P(n) and positions of the phase modulating optical amplifiers 6A(1), 6A(2), . . . 6A(n−1), 6A(n) are exchanged to each other in each phase modulation optical amplification unit PA(1), PA(2), . . . PA(n−1), P(n) of the fourth OPA 400.

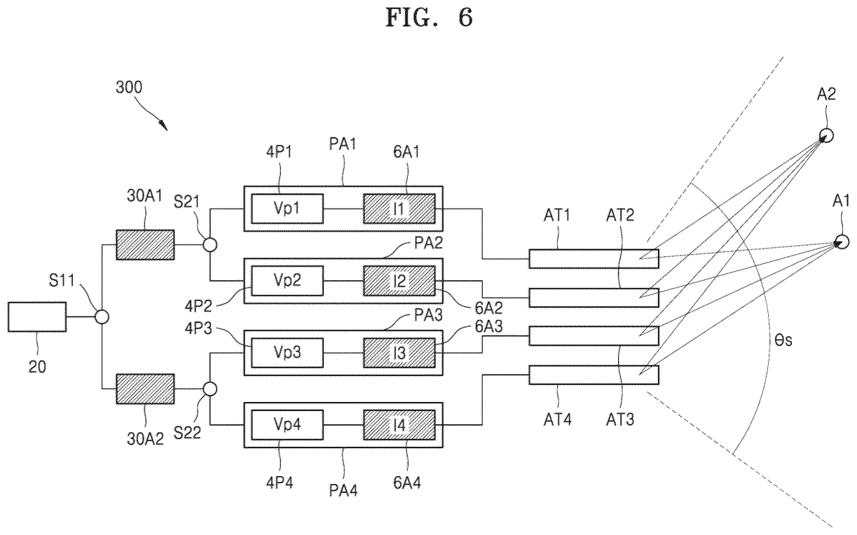

Next, a method of operating an OPA according to an example embodiment will be described. FIG. 6 shows the third OPA 300 in a simplified configuration to explain an operation method of the third OPA according to an example embodiment.

As an example, an operation method of the third OPA 300 of FIG. 3 will be described. For convenience of explanation, it is set that the number of the plurality of phase modulation optical amplification units PA(1), PA(2), . . . PA(n−1), PA(n) in the third OPA 300, as shown in FIG. 6, is limited to four, and the first stage is equipped with two optical amplifiers 30A1 and 30A2.

In the description of the operation method below, the operating principle of the phase modulation optical amplifier according to one or more example embodiments does not vary depending on the number of phase modulation optical amplifiers. Therefore, the operation method below may be equally applied even when the number of phase modulation optical amplifiers less than or more than four. In addition, the differences between the first to fifth OPAs 100 to 500 described above may be whether an optical amplifier is present or absent in the first stage, the difference in the number of optical amplifiers provided in the first stage, and the difference in arrangement or aligned order of the phase modulator 4P(1), 4P(2), . . . 4P(n−1), 4P(n) and the phase modulation optical amplifier 6A(1), 6A(2), . . . 6A(n−1), 6A(n) in each of the phase modulation optical amplification units PA(1), PA(2), . . . PA(n−1), PA(n). These differences may not affect the method of operation described below. Accordingly, the operation method described below may be the operation method of not only the third OPA 300 but also the first, second, fourth, and fifth OPAs 100, 200, 400, and 500.

Referring to FIG. 6, the operation method of the third OPA 300 may include a beamforming process of the third OPA 300, and may additionally include various operation process, such as an operation of the light source 20, an operation of the optical amplifiers 30A1 and 30A2, and an operation of the optical splitter S11, S21, and S22, etc. Each of the above operations may also include control operations of the corresponding element.

The beamforming process may include a process of focusing light emitted from the third OPA 300 toward a first region of interest (ROI) A1 outside the third OPA 300 as much as possible on the first ROI A1. In one example, the first ROI A1 may be a partial region of an object to which light is irradiated from the third OPA 300, or may be a partial region of an environment around the third OPA 300. The first ROI A1 may be a region within a scanning range or light irradiation range of the third OPA 300. A horizontal scan range of the third OPA 300 may be within 180 degrees, for example, 170 degrees or less, 150 degrees or less, 120 degrees or less, 100 degrees or less, 90 degrees or less, or 60 degrees or less, and is not limited thereto.

In the third OPA 300, the beamforming may be achieved through adjusting a phase of light transmitted through first to fourth channels ch1 to ch4, and a beamforming process in the other OPAs 100, 200, 400, and 500 described above may be the same as in the third OPA 300.

In the third OPA 300, because the phase adjustment or modulation of light transmitted through the first to fourth channels ch1 to ch4 is performed through the first to fourth phase modulation optical amplification units PA1 to PA4, the beamforming process may include a method of operating the first to fourth phase modulation optical amplification units PA1 to PA4.

The beamforming process may be regarded as a process of controlling or a process of optimizing the operation of the first to fourth phase modulation optical amplification units PA1 to PA4 such that the light emitted from the antenna array ATA of the third OPA 300 is focused as much as possible on the first ROI A1.

Therefore, in the beamforming process, the phase control or phase modulation characteristics of each of the phase modulation optical amplification units PA1 to PA4 may be optimized such that the light emitted from the antenna array ATA of the third OPA 300 is focused as much as possible on the first ROI A1. The optimization of phase control or phase modulation characteristics of each of the phase modulation optical amplification units PA1 to PA4 may be simply expressed as optimization of each phase modulation optical amplification units PA1 to PA4. A phase modulator and a phase modulation optical amplifier may be involved in the phase modulation in each of the phase modulation optical amplification units PA1 to PA4, and the phase modulation by the phase modulation optical amplifier may be accompanied by the optical amplification process by the phase modulation optical amplifier. Therefore, optimization of each phase modulation optical amplification units PA1 to PA4 may include optimization of the phase modulators 4P1 to 4P4 included in each phase modulation optical amplification units PA1 to PA4 and optimization of the phase modulation optical amplifiers 6A1 to 6A4. Control of the phase modulators 4P1 to 4P4 included in each phase modulation optical amplification units PA1 to PA4 may be achieved through a voltage applied to the phase modulators 4P1 to 4P4, and control of optical amplification of the phase modulation optical amplifiers 6A1 to 6A4 may be achieved through a current applied to the phase modulation optical amplifiers 6A1 to 6A4.

Therefore, the optimization process of each of the phase modulation optical amplification units PA1 to PA4 may ultimately include a process of optimizing the voltage applied to the phase modulators 4P1 to 4P4 included in each phase modulation optical amplification units PA1 to PA4 and a process of optimizing the current applied to the phase modulation optical amplifier 6A1 to 6A4.

In one example, the optimization of the first to fourth phase modulation optical amplification units PA1 to PA4 may be performed as follows.

Referring to FIG. 6, for the first phase modulation optical amplification unit PA1, a first phase modulation voltage Vp1 may be applied to the first phase modulator 4P1, and a first current I1 for optical amplification may be applied to the first phase modulation optical amplifier 6A1. Accordingly, light transmitted to the first phase modulation optical amplification unit PA1 may have a first phase after passing through the first modulation optical amplification unit PA1 by phase modulation by the first phase modulator 4P1 and phase modulation accompanied by an optical amplification process by the first phase modulation optical amplifier 6A1, and the light intensity may be increased in proportion to the first current I1.

For the second phase modulation optical amplification unit PA2, a second phase modulation voltage Vp2 may be applied to the second phase modulator 4P2, and a second current I2 for optical amplification may be applied to the second phase modulation optical amplifier 6A2. Accordingly, light transmitted to the second phase modulation optical amplification unit PA2 and having passed through the second phase modulation optical amplification unit PA2 may have a second phase and may be amplified.

For the third phase modulation optical amplification unit PA3, a third phase modulation voltage Vp3 may be applied to the third phase modulator 4P3, and a third current I3 may be applied to the third phase modulation optical amplifier 6A3. Accordingly, light transmitted to the third phase modulation optical amplification unit PA3 and having passed through the third phase modulation optical amplification unit PA3 may have a third phase and may be amplified.

For the fourth phase modulation optical amplification unit PA4, a fourth phase modulation voltage Vp4 may be applied to the fourth phase modulator 4P4, and a fourth current I4 may be applied to the fourth phase modulation optical amplifier 6A4. Accordingly, light transmitted to the fourth phase modulation optical amplification unit PA4 and having passed through the fourth phase modulation optical amplification unit PA4 and may have a fourth phase and may be amplified.

In one example, magnitudes of the first to fourth phase modulation voltages Vp1 to Vp4 may be the same, and magnitudes of the first to fourth currents I1 to I4 may be different from each other or at least some of the first to fourth currents I1 to I4 may be different from each other. In one example, the magnitudes of the first to fourth phase modulation voltages Vp1 to Vp4 may be different from each other or at least partially different from each other, and the magnitudes of the first to fourth currents I1 to I4 may be different from each other or at least partially different from each other. Because each of the first to fourth currents I1 to I4 is used for current amplification, the magnitude of each current may be greater than 0.

In one example, the first to fourth phases may be the same or different from each other, or at least some of them may be different from each other. Each of the first to fourth phases may be approximately 0 to 2π. In one example, a phase difference between the first to fourth phases may be constant or different. For example, there may be a first phase difference between the first phase and the second phase, a second phase difference between the second phase and the third phase, and a third phase difference between the third phase and the fourth phase. The first to third phase differences may be the same or different from each other. In one example, among the first to third phase differences, two phase differences may be the same as each other and may be different from the remaining phase difference. The magnitude of each of the first to third phase differences may be greater than 0 and less than 2π.

To optimize the first to fourth phase modulation optical amplification units PA1 to PA4, the first to fourth phase modulation voltages Vp1 to Vp4 and the first to fourth currents I1 to I4 may be adjusted. The optimization may be a process of repeating the adjustment of the first to fourth phase modulation voltages Vp1 to Vp4 and the first to fourth currents I1 to I4.

In one example, in a first operation for the optimization, the first to fourth phase modulation voltages Vp1 to Vp4 may be kept constant at a first voltage, and the first to fourth currents I1 to I4 may respectively be adjusted within a first specified current range. In a second operation for optimization, the first to fourth phase modulation voltages Vp1 to Vp4 are maintained at a second voltage different from the first voltage, and the first to fourth currents I1 to I4 may respectively be adjusted within a second specified current range. The first specified current range may be the same or different from the second specified current range. Thereafter, these operations may be repeated a set number of times while changing the first to fourth phase modulation voltages Vp1 to Vp4. In one example, the first to fourth currents I1 to I4 may be changed by changing the first phase modulation voltage Vp1, and this operation may be repeated up to the operation of changing the fourth phase modulation voltage Vp4 (e.g., repeating operations by sequentially changing the first phase modulation voltage Vp1, the second phase modulation voltage Vp2, the third phase modulation voltage Vp3, and the first phase modulation voltage Vp4).

In one example, while changing the first phase modulation voltage Vp1, the second to fourth phase modulation voltages Vp2 to Vp4 may be maintained at constant values, and while changing the fourth phase modulation voltage Vp4, the first to third phase modulation voltages Vp1 to Vp3 may be maintained at a constant value but are not limited thereto.

In this optimization process, at an end of each operation, a shape or a beam profile of a beam focused in the first ROI A1 is checked, and in a next operation, whether to change or maintain any one of the first to fourth phase modulation voltages Vp1 to Vp4 applied to the first to fourth phase modulators 4P1 to 4P4 and/or a degree of change thereof may be determined, and whether to change or maintain any one of the first to fourth currents I1 to I4 applied to the first to fourth phase modulation optical amplifiers 6A1-6A4 and/or a degree of change thereof may be determined.

Profiles of the first to fourth phase modulation voltages Vp1 to Vp4 and the first to fourth currents I1 to I4 to be applied in the next operation, that is, the degree of change in the first to fourth phase modulation voltages Vp1 to Vp4 and the degree of change in the first to fourth currents I1 to I4 may be determined using an algorithm based on the shape of a beam formed in the first ROI A1. In one example, an algorithm, such as, but is not limited to, a genetic algorithm, gradient descent, or hill climb may be used as the algorithm. The first to fourth phase modulation voltages Vp1 to Vp4 to be applied to the first to fourth phase modulators 4P1 to 4P4 determined from the profiles of the first to fourth phase modulation voltages Vp1 to Vp4 obtained through the algorithm may be respectively applied to the first to fourth phase modulators 4P1 to 4P4 through a drive board. The first to fourth currents I1 to I4 to be applied to the first to fourth phase modulation optical amplifiers 6A1-6A4 determined from the profiles of the first to fourth current I1 to I4 obtained through the algorithm may also be respectively applied to the first to fourth phase modulation optical amplifiers 6A1-6A4 through the drive board.

This process may be repeated until the optimization of the first ROI A1 is completed.

As a result, the optimization process for the first ROI A1 may be viewed as a process of finding a combination, that maximizes the light intensity in the ROI A1, of the first to fourth phase modulation voltages Vp1 to Vp4 and the first to fourth currents I1 to I4. The combination that maximizes the light intensity may be a combination when the light intensity of the first ROI A1 becomes a set intensity or a combination when the light intensity becomes closest to the set intensity.

In one example, after the optimization process for the first ROI A1 is completed, a second ROI A2 may be set and optimization for the second ROI A2 may be performed. The optimization process for the second ROI A2 may be performed in the same manner as the optimization for the first ROI A1.

The second ROI A2 may be a region spaced apart from the first ROI A1. For example, in the same horizontal plane, a center of the first ROI A1 may be at a first angle from a baseline, and a center of the second ROI A2 may be at a second angle from the baseline. The first angle may be different from the second angle. In one example, the first angle may be 15° and the second angle may be 25°. The first and second angles may be angles within a beam steering range θs of the third OPA 300 in the horizontal plane. The beam steering range θs may be expressed as a scan range.

After performing the optimization for the second ROI A2, optimization of other ROIs within the scan range es of the third OPA 300 may also be performed in the same manner as the optimization of the first ROI A1.

In this way, the optimization for the third OPA 300 may be completed, a lookup table for beam steering for each ROI may be formed using data of voltages and currents applied to the first to fourth phase modulation optical amplification units PA1 to PA4 obtained in the optimization process.

In one example, the first and second ROIs A1 and A2 may be at a same first height, and after beamforming for another region at the first height is completed, that is, after one-dimensional beam steering is completed, a vertical angle emitted from the OPA 300 may be adjusted by changing a wavelength of light emitted from the light source 20. In this way, optimization (beamforming) for an ROI at a second height different from the first height may be performed in the same manner as optimization for the first ROI A1. That is, a two-dimensional beam steering may be performed by changing the wavelength of light emitted from the light source 20.

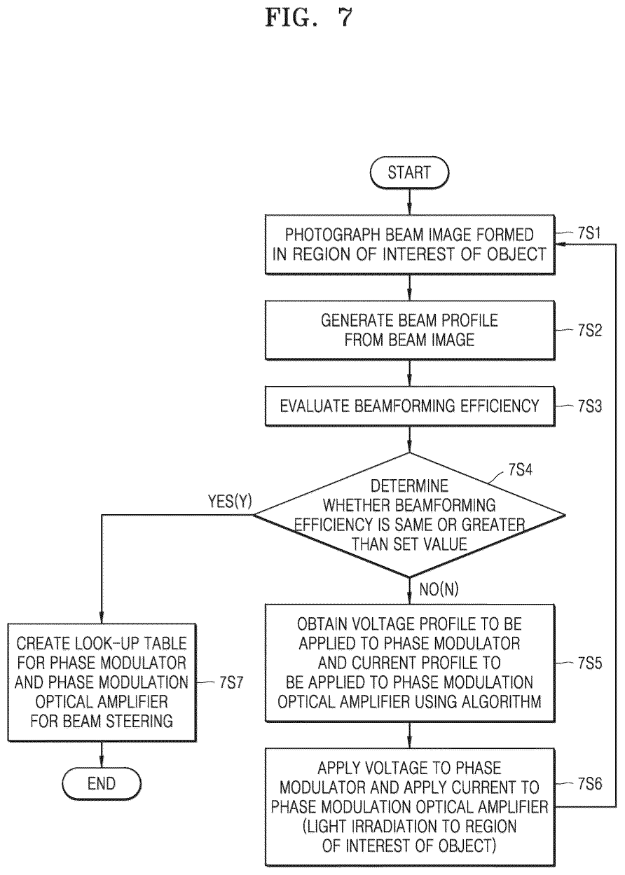

FIG. 7 is a flowchart showing an operation method of an OPA according to an example embodiment. The operation method of FIG. 7 may correspond to operations of the third OPA 300 described above, and may be equally applied to the other OPAs 100, 200, 400, and 500.

Referring to FIG. 7, the operating method of the third OPA 300 may first acquire a beam image formed in a region of interest of an object (7S1). The beam image may be obtained by capturing (e.g., photographing) the object including the region of interest using an imaging device (e.g., an infrared camera).

Next, a beam profile may be generated from the beam image acquired in operation 7S1 (7S2). The beam profile may include information about light intensity distribution in the region of interest. In one example, instead of acquiring the beam image by capturing an image with an imaging device, the beam image may be obtained using a detector after forming the detector in an OPA chip.

Next, a beamforming efficiency (BFE) for the region of interest may be evaluated from the beam profile generated in operation 7S2 (7S3). The beamforming efficiency may be evaluated by comparing a reference light intensity (or reference beam profile) set in the region of interest with the beam profile generated in operation 7S2 but is not limited thereto.

Next, it may be determined whether the beamforming efficiency in the region of interest evaluated in operation 7S3 is equal to or greater than a set value (e.g., reference beamforming efficiency value) (7S4).

As a result of the determination in operation of 7S4, if the beamforming efficiency evaluated in operation 7S3 is equal to or greater than the set value (Yes (Y)), a lookup table for the phase modulator and the phase modulation optical amplifier may be created (7S7).

As a result of the determination in operation 7S4, if the beamforming efficiency evaluated in operation 7S3 is not equal to or greater than the above set value (No (N)), that is, if the evaluated beamforming efficiency in operation 7S3 is lower than the above set value, a voltage profile to be applied to the phase modulator and a current profile to be applied to the phase modulation optical amplifier may be obtained using an algorithm (7S5).

Next, based on the voltage and current profiles obtained in operation 7S5, a voltage may be applied to the phase modulator and a current may be applied to the phase modulation optical amplifier (7S6). The application of voltage and current in operation 7S6 may be performed using a drive board. By applying a voltage to the phase modulator and applying a current to the phase modulation optical amplifier, the phase modulated and amplified light may be emitted to the region of interest through the antenna array ATA, and thus, operation 7S6 may be an operation of irradiating light to the region of interest of the object.

Thereafter, the method may return to operation 7S1 and the above processes may be repeated from operation 7S1 until the beamforming efficiency of the region of interest is equal to or greater than the set value.

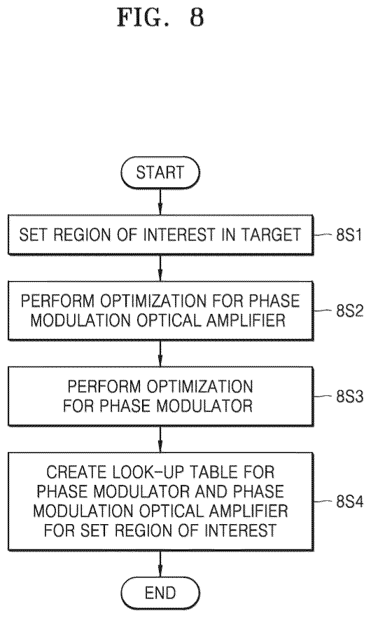

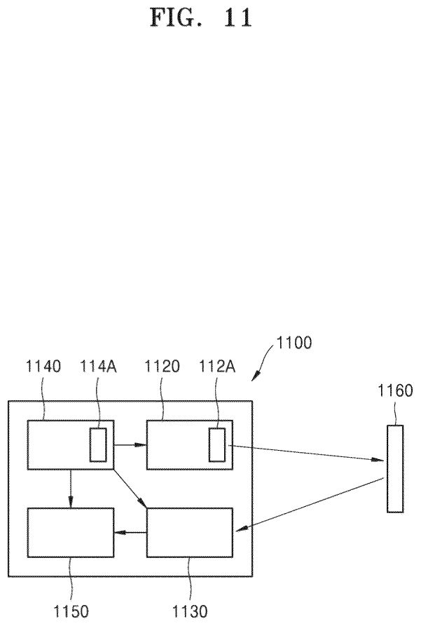

Next, a simulation and its result are described with reference to FIGS. 8 and 11. As described below, the simulation shows that the beamforming efficiency and light intensity increase in the region of interest of an object when the OPA operation method according to the embodiment described above is used.

In the simulation, the OPA operation method was divided into a first operation method and a second operation method.

Hereinafter, the first operation method refers to an operation method of an OPA according to an example embodiment, and the second operation method refers to a comparative method that is provided for comparison with the first operation method. The second operation method is an operation method of applying the same current to all phase modulation optical amplifiers of the phase modulation optical amplification units in the operation of the OPA according to an example embodiment. That is, the second operation method is a method in which phase modulation is performed only with the phase modulator of the phase modulation optical amplifier, and the optimization for beamforming is performed using only the phase modulator, similar to an existing optimization method. Therefore, the second operation method may correspond to an existing optimization method for beamforming, except that the second operation method was applied to the OPA according to an example embodiment.

In the above simulation, the first and second operation methods were performed on the fourth OPA 400 shown in FIG. 4 but may also be performed on any one of the OPAs shown in FIGS. 1 to 3 and FIG. 5.

In the above simulation, a current applied to each of the third to sixth optical amplifiers 40A3 to 40A6 disposed between the light source 20 and the plurality of phase modulation optical amplification units PA(1), PA(2), . . . PA(n−1), PA(n) of the fourth OPA 400 of FIG. 4 used in the first and second operation methods was set to be the same. In addition, in the simulation of the first operation method, a range of current applied to each phase modulation optical amplifier 6A(1), 6A(2), . . . 6A(n−1), 6A(n) was set to be in a range from about 40 mA to about 300 mA, and the voltage applied to each phase modulator 4P(1), 4P(2), . . . 4P(n−1), 4P(n) was set to in a range from about 1300 mV to about 1700 mV. The number of channels of the fourth OPA 400 was set to 64. Accordingly, in the simulation, the number of phase modulation optical amplifiers of the fourth OPA 400 was set to 64, and the number of phase modulators was also set to 64.

The simulation was performed such that, as a first simulation, optimization was performed according to the first and second operation methods for one region of interest (corresponding to one scan angle) belonging to a scan range or beam steering range of the fourth OPA 400, and as a second simulation, optimization was performed according to the first and second operation methods with respect to multiple regions of interest (corresponding to multiple scan angles) within the above scan range. In the second simulation, the scan range was set to 60 degrees, and the number of regions of interest was set to 60. That is, in the second simulation, optimization was performed on 60 points within a scan range of 60 degrees.

FIG. 8 is a flowchart illustrating the first operation method of a simulation according to an example embodiment.

Referring to FIG. 8, the first operation method includes setting a region of interest in a target (e.g., object) (8S1), optimizing the phase modulation optical amplifier (8S2), optimizing the phase modulator (8S3), and creating a lookup table that includes optimization data of the phase modulation optical amplifier and phase modulator for the set region of interest (8S4).

The region of interest set in operation 8S1 may be a region or point at a first angle (e.g., 5° or 20°) within a beam steering angle range of the OPA.

Operation 8S2 may be a process of optimizing the phase modulation optical amplifiers 6A1 to 6A64 in 64 channels with respect to the region of interest set in operation 8S1, and may be a process of finding current application conditions (or current profiles) for 64 phase modulation optical amplifiers that may collect maximum light (e.g., maximize beam forming efficiency) in the set region of interest. Because there may be numerous combinations of the 64 phase modulation optical amplifiers, in order to reduce cost and save time, the process of finding the current application conditions for the 64 phase modulation optical amplifiers may be performed by selecting only some combinations among all of possible combinations through an algorithm. The algorithms may include, but are not limited to, genetic algorithms, gradient descent, or hill climbing. According to the current application conditions of each combination selected by the algorithm, currents of different sizes may be applied to 64 phase modulation optical amplifiers through a drive board, and accordingly, light may be emitted to the set region of interest, and beamforming may be performed in the set region of interest. As currents of different magnitudes are applied to the 64 phase modulation optical amplifiers, the 64 phase modulation optical amplifiers may have different optical amplification rates.

In this way, the beamforming performed in the set region of interest for each combination may be captured (e.g., photographed) with an infrared camera, and a beam profile for the corresponding beamforming may be obtained. By comparing these beam profiles of each combination, current application conditions that may maximize beamforming efficiency and light intensity in the set region of interest may be found. The current application conditions found in this way become the optimized current application conditions for 64 phase modulation optical amplifiers, and optimization of the phase modulation optical amplifiers may be completed. In operation 8S2, voltages applied to all 64 phase modulators were kept constant (e.g., all were maintained at 0V or maintained at 1500 mV, which is the middle of the set voltage scan range).

Operation 8S3 may be a process of optimizing the 64 phase modulators 4P1 to 4P64 in 64 channels for the set region of interest and may be a process of finding voltage application conditions (e.g., voltage profiles) for 64 phase modulators that may collect maximum light in the set region of interest (e.g., beamforming efficiency is maximized). This process may be performed in the same way as the process of finding optimal current application conditions for the 64 phase modulation optical amplifiers 6A1 to 6A64 described in operation 8S2, and the same algorithm can be used.

In operation 8S3, the applied current to the 64 phase modulation optical amplifiers was maintained constant at a value greater than 0 (e.g., 100 mA).

In operation 8S4, a lookup table that may be used for beam steering for the set region of interest is created based on the optimized current application condition for the 64 phase modulation optical amplifiers obtained in operation 8S2 and the optimized voltage application condition for the 64 phase modulators obtained in operation 8S3.

Through operations 8S1 to 8S4 of FIG. 8, optimization of the phase modulator and phase modulation optical amplifier for beamforming for one region of interest within a scan range (or beam steering range) of the fourth OPA 400 may be achieved, and a lookup table may also be created. As a result, the optimization and the creation of a lookup table according to the first operation method shown in FIG. 8 may correspond to performing the first simulation.

Operations 8S1 to 8S4 of FIG. 8 may also be applied to beamforming and lookup table creation for other regions of interest within the scan range of the fourth OPA 400. For example, by applying operations 8S1 to 8S4 of FIG. 8 to each of the 60 regions of interest (e.g., points) at different scan angles within the scan range, beamforming for the 60 regions of interest may be completed, and a lookup table for beam steering may also be created. This may correspond to performing the second simulation.

The second operating method of the simulation is to optimize beamforming for the set region of interest using only a phase modulator. Therefore, the second operation method may be the same as omitting operation 8S2 in the first operation method of FIG. 8 and only creating a lookup table of the phase modulator in operation 8S4. Therefore, in the second operation method, the 64 phase modulators may be optimized by applying different voltages from each other within the set voltage range, and the current applied to each of the 64 phase modulation optical amplifiers was maintained at a constant value until the optimization process for the 64 phase modulators was completed.

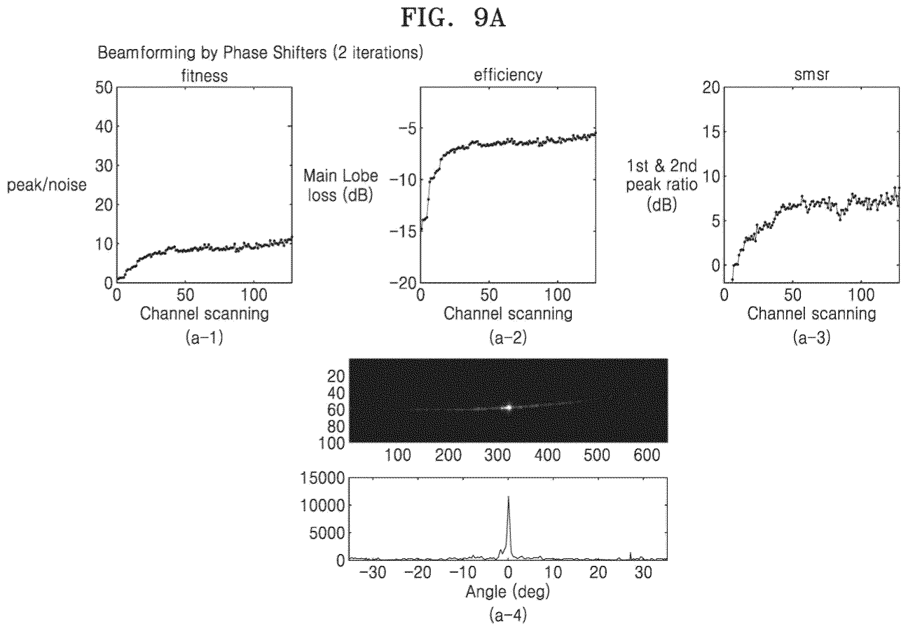

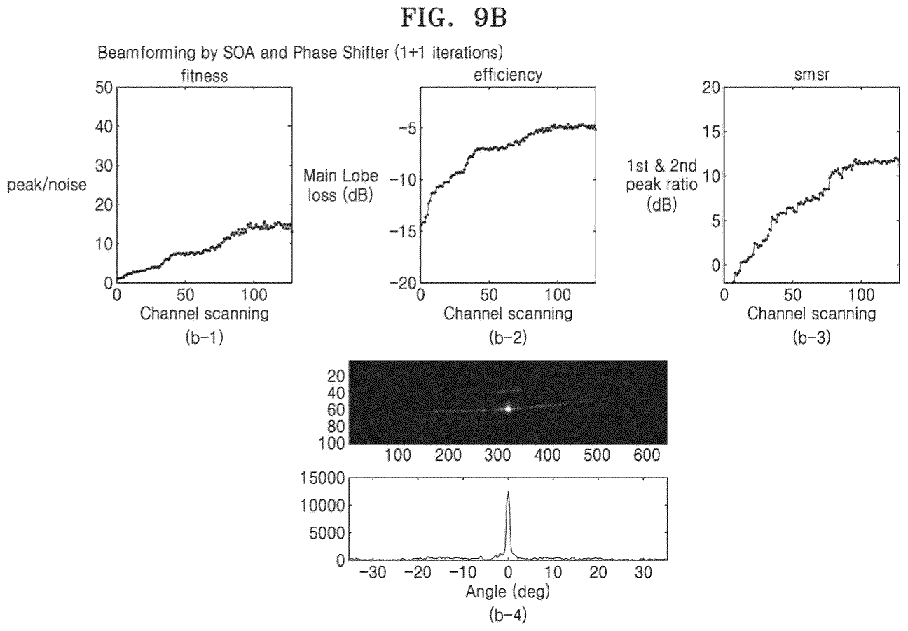

FIGS. 9A and 9B show results of the first simulation according to the first and second operating methods.

FIG. 9A shows results of the first simulation related to optimization (e.g., beamforming result) according to the second operation method, and FIG. 9B shows results of the first simulation related to optimization (e.g., beamforming result) according to the first operation method. In the first simulation, optimization according to each operation method was repeated twice.

In FIGS. 9A and 9B, a horizontal axis represents 128 OPA channels. Among the 128 channels, channels 1 to 64 correspond to first optimized channels 1-64, and channels 65 to 128 correspond to channels 1 to 64 that were second optimized following the first optimization. In other words, for an OPA including 64 channels, optimization is performed twice for the 64 channels. The 64 channels that have been optimized once are displayed as channels 1 to 64, and the 64 channels that have been optimized twice are displayed as channels 65 to 128. If optimization is repeated three times for the 64 channels, the 64 channels that have been optimized three times will be displayed as channels 129 to 192. Therefore, on the horizontal axis of FIGS. 9A and 9B, channel 65 may be the same channel as channel 1, and channel 128 may be the same channel as channel 64.

Referring to FIGS. 9A and 9B, in (a-1) and (b-1), a vertical axis represents a ratio of light peak power in a set region of interest to an amount of background noise light around the set area of interest in a beam profile for a beam image formed in the set region of interest. In (a-2) and (b-2), a vertical axis represents a beamforming efficiency in the beam profile and represents a ratio of an amount of light focused on the set area of interest to a total amount of light emitted from the OPA toward the set area of interest. In (a-3) and (b-3), a vertical axis represents a side mode suppression ratio (SMSR) and represents a height of a first peak compared to a height of a second peak in the beam profile in a decibel (dB) unit. In (a-4) and (b-4), an image in an upper portion shows an image taken with an infrared camera having the beam profile for the beam image formed in the set region of interest, and a graph in a lower portion shows light intensity distribution with respect to when the image in the upper portion is cut horizontally to pass through a center of the beam profile.

Comparing FIGS. 9A and 9B, beamforming efficiency and peak power increase as optimization is repeated for both the first and second operation methods. However, it may be seen that the beamforming efficiency (b-2) and peak power (b-1, b-3, and b-4) of FIG. 9B are much greater than those of FIG. 9A.

That is, the results of FIGS. 9A and 9B suggest that, when the OPA is driven by the OPA operation method (e.g., the first operation method) according to an example embodiment, the beamforming efficiency of the region of interest may be increased and the optical peak power of the region of interest may also be increased than when the OPA is driven by the existing OPA operation method (e.g., the second operation method).

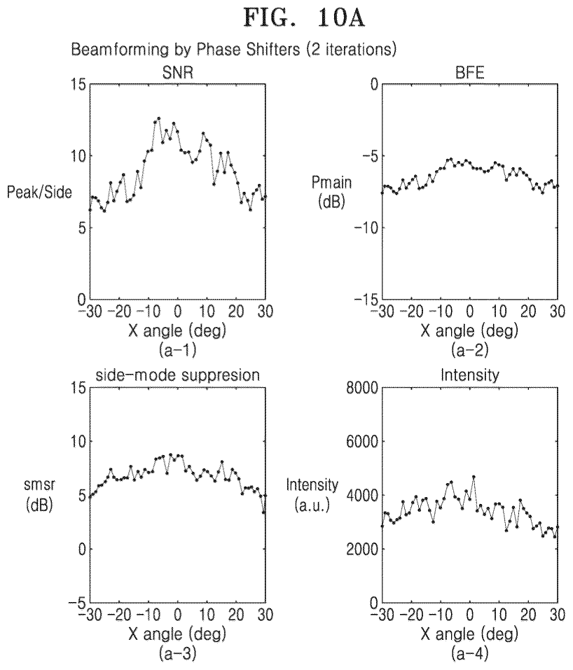

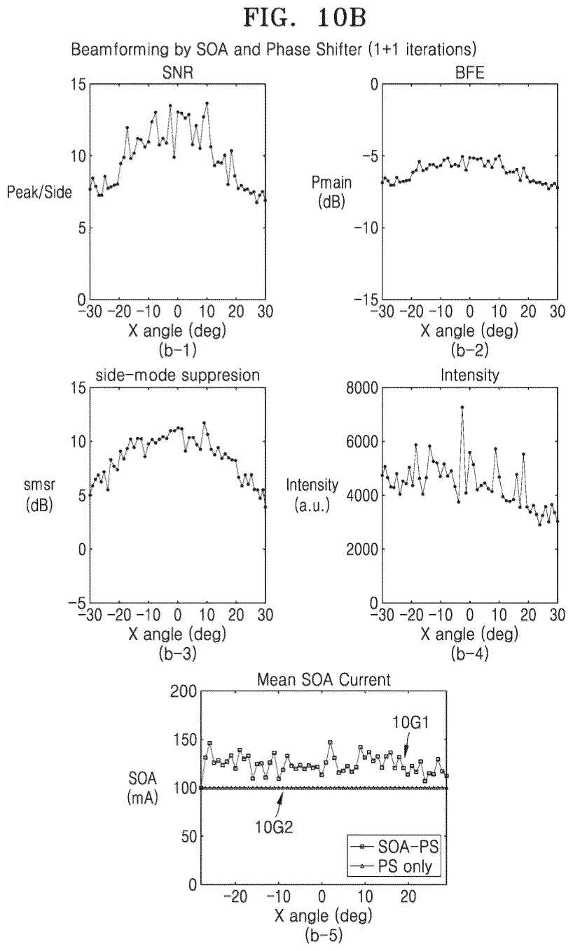

FIGS. 10A and 10B show results of the second simulation according to the first and second operating methods.

FIG. 10A shows results of the second simulation related to optimization (e.g., beamforming results) for 60 regions (e.g., points) at different steering angles (e.g., scan angles) within the beam steering range according to the second operation method. FIG. 10B shows results of the second simulation related to optimization (beamforming results) for the 60 regions (e.g., points) according to the first operation method. In the second simulation, optimization for each operation method was repeated twice.

FIGS. 10A and 10B, a horizontal axis represents an emission angle or beam steering angle (e.g., scan angle) of light emitted from the OPA.

Referring to FIGS. 10A and 10B, in (a-1) and (b-1), a vertical axis represents a signal to noise ratio (SNR) of each of the 60 regions, and represents a ratio of intensity of the maximum optical peak in each region to background noise intensity around each region expressed in decibels (dB). If the SNR is 10 dB, it means that the intensity of the maximum optical peak is 10 times compared to a noise average (or background noise). (a-2) and (b-2) represent beamforming efficiency (BEF), and a vertical axis thereof represents a maximum optical peak intensity of each region. Beamforming efficiency may be represented by a ratio of an amount of light focused in each region to a total amount of light emitted from the OPA and the beamforming efficiency may be 1 (0 dB) or less.

The higher the beamforming efficiency, the more light emitted from the OPA may be collected in the region of interest, light may be irradiated to a greater distance, and thus, a beam steering range or scanning range of the OPA may be wider and deeper. Also, if there is a region of interest at the same distance, the region of interest may be recognized more clearly and accurately with higher beamforming efficiency, and more information about the region of interest may be obtained.

In (a-3) and (b-3), a vertical axis represents SMSR.

In (a-4) and (b-4), a vertical axis represents light intensity of each region, which represents a total amount of beams focused on each region and corresponds to an integration of pixel values of an image of each region acquired with an infrared camera.

In FIG. 10B, (b-5) shows a first graph 10G1 that represents an average value of a current applied to the phase modulation optical amplifier in each region determined as optimization is completed according to the first operation method for each of the 60 regions. In (b-5), in addition to the first graph 10G1 that represents an average value of current applied to the phase modulation optical amplifier for each region when optimization of each region is completed according to the first operation method, a second graph 10G2 is shown for comparison. The second graph 10G2 represents an average value of current applied to the phase modulation optical amplifier for each region when optimization of each region is completed according to the second operation method.

The second operation method is a related art operation method, and because the current applied to the phase modulation optical amplifier is the same during the optimization process for all 60 regions, the average value of the current applied to the phase modulation optical amplifier for each region is also the same in all 60 regions (as shown in the second graph 10G2).

On the other hand, if optimization is performed according to the first operation method, the average value of the current applied to the phase modulation optical amplifier for each region may be different in the 60 regions, as may be seen in the first graph 10G1, and may differ from each other in at least some regions.

Comparing the first and second graphs 10G1 and 10G2, if optimization is performed according to the first operation method, the average value of current applied to the phase modulation optical amplifier for each region is greater than the average value of the current applied to the phase modulation optical amplifier in each region when optimization is performed according to the second operation method.

Table 1 below shows the average values of the results of the second simulation as shown in FIGS. 10A and 10B.

TABLE 1

| | Peak_avg (a.u.) | SNR (dB) | BFE (dB) | SMSR(dB) |
|---|---|---|---|---|
| PS | 3398 | 8.82 | −6.46 | 6.71 |
| PS + SOA | 4402 | 9.76 | −6.13 | 8.42 |

In Table 1, “Peak avg” represents an average light intensity of the 60 regions, “SNR” represents an average SNR of the 60 regions, “BFE” represents an average beamforming efficiency of the 60 regions, and “SMSR” represents an average SMSR of the 60 regions.

“PS” indicates a case when optimization (or beam forming) was performed using only a phase modulator for optical phase modulation, and corresponds to a case when optimization was performed according to the second operation method.

“PS+SOA” refers to a case when optimization (or beam forming) was performed by using a phase modulator together with a phase modulation optical amplifier for optical phase modulation, and corresponds to a case when optimization was performed according to the first operation method.

Comparing FIGS. 10A and 10B, it may be seen that all characteristics, such as SNR, BFE, SMSR, and light intensity were improved when optimization was performed using the first operation method compared to when optimization was performed using the second operation method, and Table 1 numerically provides these results.

The OPAs according to one or more example embodiments described above may be provided as one of parts or elements included in an electronic device or may be provided as an electronic device itself that may be combined with other electronic device(s). The other electronic device that may be combined may include any one of general vehicles, autonomous vehicles, manned and unmanned aerial vehicles, robots, and mobile phones, etc. In addition, the OPAs described above may be applied to various devices for recognizing an object and/or obtaining information about the object using light.

As an example, FIG. 11 shows a first electronic device 1100 according to an example embodiment. The first electronic device 1100 may be a light detection and ranging (LiDAR) device.

Referring to FIG. 11, the first electronic device 1100 may include a light source unit 1120 that irradiates light to an object 1160, a receiver 1130 configured to receive light reflected from the object 1160, a processor 1150 that processes a given image from the light source unit 1120, and a controller 1140 that controls an overall operation of the first electronic device 1100. The first electronic device 1100 may further include other elements related to the operation of the first electronic device 1100. The controller 1140 may be provided to control the operations of the light source unit 1120, the receiver 1130, and/or the processor 1150, and may include a configuration for controlling the above element(s). In one example, the light source unit 1120 may include an OPA 112A configured to emit light toward the object 1160. In one example, the OPA 112A may include one of OPAs 100 to 500 according to the example embodiments described above or one of OPAs that is based on a combination of the OPAs 100 to 500.

In one example, the controller 1140 may include a drive board 114A configured to control an operation of the OPA 112A. A voltage and a current may be applied to the phase modulator and/or phase modulation optical amplifier of the OPA 112A through the drive board 114A. In one example, the drive board 114A may be included in the light source unit 1120.

The controller 1140 may provide a synchronization signal related to light emission from the light source unit 1120 and a synchronization signal related to light reception from the receiver 1130, etc.

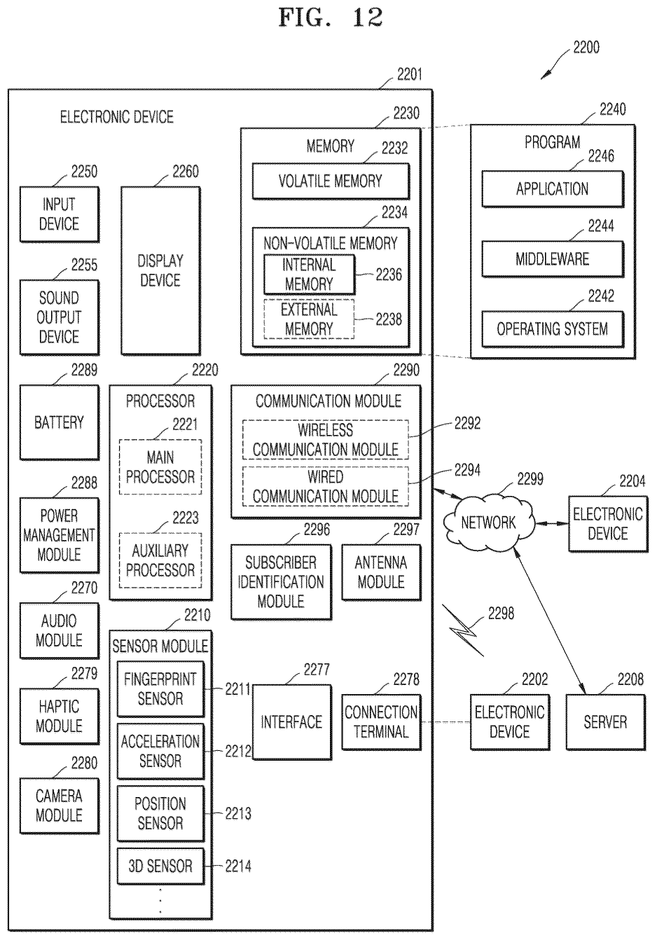

FIG. 12 is a block diagram showing a schematic configuration of a second electronic device 2200 according to an example embodiment.

Referring to FIG. 12, in a network environment 2200, an electronic device 2201 may communicate with another electronic device 2202 through a first network 2298 (e.g., a short-range wireless communication network, etc.) or may communicate with another electronic device 2204 and/or a server 2208 through a second network 2299 (e.g., a long distance wireless communication network). The electronic device 2201 may communicate with the electronic device 2204 through the server 2208. The electronic device 2201 may include a processor 2220, a memory 2230, an input device 2250, an audio output device 2255, a display device 2260, an audio module 2270, a sensor module 2210, an interface 2277, a haptic module 2279, a camera module 2280, a power management module 2288, a battery 2289, a communication module 2290, a subscriber identification module 2296, and/or an antenna module 2297.

In one example, the semiconductor device described with reference to FIGS. 1 to 6 may be included in at least one of the processor 2220, memory 2230, input device 2250, audio output device 2255, display device 2260, audio module 2270, sensor module 2210, interface 2277, haptic module 2279, camera module 2280, power management module 2288, communication module 2290, subscriber identification module 2296, and antenna module 2297.

In the electronic device 2201, some of these components (e.g., the display device 2260) may be omitted or other components may be added. Some of these components may be implemented as one integrated circuit. For example, a fingerprint sensor 2211 of the sensor module 2210, an iris sensor, an illuminance sensor, etc. may be implemented in a form embedded in the display device 2260 (e.g., a display, etc.).

The processor 2220 may execute software (e.g., a program 2240, etc.) to control one or a plurality of other components (e.g., hardware, software components, etc.) of the electronic device 2201 connected to the processor 2220, and may perform various data processing or operations. As part of data processing or operations, the processor 2220 may load commands and/or data received from other components (e.g., the sensor module 2210, the communication module 2290, etc.) into a volatile memory 2232, and may process commands and/or data stored in the volatile memory 2232, and store resulting data in a non-volatile memory 2234. The processor 2220 may include a main processor 2221 (e.g., a central processing unit, an application processor, etc.) and an auxiliary processor 2223 (e.g., a graphics processing unit, an image signal processor, a sensor hub processor, a communication processor, etc.) that may be operated independently or together with the main processor 2221. The auxiliary processor 2223 may use less power than the main processor 2221 and may perform a specialized function.

The auxiliary processor 2223 may control functions and/or states related to some of the components (e.g., the display device 2260, the sensor module 2210, the communication module 2290) of the electronic device 2201 instead of the main processor 2221 while the main processor 2221 is in an inactive state (e.g., sleep state), or together with the main processor 2221 while the main processor 2221 is in an active state (e.g., application execution state). The auxiliary processor 2223 (e.g., an image signal processor, a communication processor, etc.) may be implemented as a part of other functionally related components (e.g., the camera module 2280, the communication module 2290, etc.).

The memory 2230 may store various data required by components of the electronic device 2201 (e.g., the processor 2220, the sensor module 2276, etc.). The data may include, for example, input data and/or output data for software (e.g., such as the program 2240) and instructions related to the command. The memory 2230 may include a volatile memory 2232 and/or a non-volatile memory 2234. The non-volatile memory 2234 may include an internal memory 2236 and an external memory 2238. The program 2240 may be stored as software in the memory 2230, and may include an operating system 2242, middleware 2244, and/or an application 2246.

The input device 2250 may receive commands and/or data to be used in a component (e.g., the processor 2220) of the electronic device 2201 from the outside of the electronic device 2201 (e.g., a user). The input device 2250 may include a microphone, a mouse, a keyboard, and/or a digital pen (e.g., a stylus pen).

The sound output device 2255 may output a sound signal to the outside of the electronic device 2201. The sound output device 2255 may include a speaker and/or a receiver. The speaker may be used for general purposes, such as multimedia playback or recording playback, and the receiver may be used to receive incoming calls. The receiver may be integrated as a part of the speaker or may be implemented as an independent separate device.

The display device 2260 may visually provide information to the outside of the electronic device 2201. The display device 2260 may include a control circuit for controlling a display, a hologram device, or a projector and a corresponding device. The display device 2260 may include a touch circuitry configured to sense a touch, and/or a sensor circuitry configured to measure the intensity of force generated by the touch (e.g., a pressure sensor, etc.).

The audio module 2270 may convert a sound into an electric signal or, conversely, convert an electric signal into a sound. The audio module 2270 may obtain a sound through the input device 2250 or may output a sound through a speaker and/or headphone of the sound output device 2255 and/or another electronic device (e.g., the electronic device 2202) directly or wirelessly connected to electronic device 2201.

The sensor module 2210 may detect an operating state (e.g., power, temperature, etc.) of the electronic device 2201 or an external environmental state (e.g., user state, etc.), and may generate an electrical signal and/or data value corresponding to the sensed state. The sensor module 2210 may include a fingerprint sensor 2211, an acceleration sensor 2212, a position sensor 2213, a 3D sensor 2214, and the like, and in addition to the above sensors, may include an iris sensor, a gyro sensor, a barometric pressure sensor, a magnetic sensor, a grip sensor, a proximity sensor, a color sensor, an infrared (IR) sensor, a biometric sensor, a temperature sensor, a humidity sensor, and/or an illuminance sensor.

The 3D sensor 2214 may sense a shape and movement of an object by irradiating a predetermined light to the object and analyzing light reflected from the object, and may include a meta-optical device. In one example, the 3D sensor 2214 may include one of the OPAs 100 to 500 according to the embodiments described above or a combination of the OPAs 100 to 500 and also may include the LIDAR 1100 illustrated in FIG. 11.

The interface 2277 may support one or more designated protocols that may be used by the electronic device 2201 to connect directly or wirelessly with another electronic device (e.g., the electronic device 2102). The interface 2277 may include a High Definition Multimedia Interface (HDMI), a Universal Serial Bus (USB) interface, an SD card interface, and/or an audio interface.

The connection terminal 2278 may include a connector through which the electronic device 2201 may be physically connected to another electronic device (e.g., the electronic device 2202). The connection terminal 2278 may include an HDMI connector, a USB connector, an SD card connector, and/or an audio connector (e.g., a headphone connector).

The haptic module 2279 may convert an electrical signal into a mechanical stimulus (e.g., vibration, movement, etc.) or an electrical stimulus that the user may perceive through tactile or kinesthetic sense. The haptic module 2279 may include a motor, a piezoelectric element, and/or an electrical stimulation device.

The camera module 2280 may capture still images and moving images. The camera module 2280 may include a lens assembly including one or more lenses, image sensors, image signal processors, and/or flashes. The lens assembly included in the camera module 2280 may collect light emitted from an object, which is an imaging target. In one example, the camera module 2280 may be provided to capture at least one of a visible light image and an infrared image of the object. In one example, the image signal processor included in the camera module 2280 may perform an operation for converting the captured infrared image into a visible light image and also an operation of overlapping the captured infrared image on the visible light image. In one example, the camera module 2280 may include an infrared camera for recognizing an object or obtaining information about the object, and the infrared camera may include one of the OPAs 100 to 500 according to the embodiments described above or a combination of the OPAs 100 to 500 and also may include the LIDAR 1100 illustrated in FIG. 11.

The power management module 2288 may manage power supplied to the electronic device 2201. The power management module 2288 may be implemented as part of a Power Management Integrated Circuit (PMIC).

The battery 2289 may supply power to components of the electronic device 2201. The battery 2289 may include a non-rechargeable primary cell, a rechargeable secondary cell, and/or a fuel cell.

The communication module 2290 may establish a direct (e.g., wired) communication channel and/or wireless communication channel between the electronic device 2201 and other electronic devices (e.g., the electronic device 2202, an electronic device 2204, server 2208, etc.) and may support the performance of communication through the established communication channels. The communication module 2290 may include one or more communication processors that operate independently of the processor 2220 (e.g., an application processor) and support direct communication and/or wireless communication. The communication module 2290 may include a wireless communication module 2292 (e.g., a cellular communication module, a short-range wireless communication module, a Global Navigation Satellite System (GNSS, etc.) communication module) and/or a wired communication module 2294 (e.g., a Local Area Network (LAN) communication module, or a power line communication module, etc.). Among these communication modules, a corresponding communication module may communicate with other electronic devices through the first network 2298 (e.g., a short-range communication network, such as Bluetooth, WiFi Direct, or Infrared Data Association (IrDA)) or the second network 2299 (e.g., a telecommunication network, such as a cellular network, the Internet, or a computer network (LAN) and WAN, etc.). The various types of communication modules may be integrated into one component (e.g., a single chip, etc.) or implemented as a plurality of components (e.g., plural chips) separate from each other. The wireless communication module 2292 may identify and authenticate the electronic device 2201 within a communication network, such as the first network 2298 and/or the second network 2299 by using subscriber information (e.g., International Mobile Subscriber Identifier (IMSI)) stored in a subscriber identification module 2296.

The antenna module 2297 may transmit or receive signals and/or power to and from the outside (e.g., other electronic devices, etc.). The antenna may include a radiator having a conductive pattern formed on a substrate (e.g., PCB, etc.). The antenna module 2297 may include one or a plurality of antennas. If a plurality of antennas is included in the antenna module 2297, an antenna suitable for a communication method used in a communication network, such as the first network 2298 and/or the second network 2299 from among the plurality of antennas may be selected by the communication module 2290. Signals and/or power may be transmitted or received between the communication module 2290 and another electronic device through the selected antenna. In addition to the antenna, other components (e.g., an RFIC, etc.) may be included as a part of the antenna module 2297.

Some of the components are connected to each other through a communication method between peripheral devices (e.g., a bus, a General Purpose Input and Output (GPIO), a Serial Peripheral Interface (SPI), a Mobile Industry Processor Interface (MIPI), etc.), and may interchange signals (e.g., commands, data, etc.).

The command or data may be transmitted or received between the electronic device 2201 and the external electronic device 2204 through the server 2208 connected to the second network 2299. The other electronic devices 2202 and 2204 may be the same or different types of electronic device 2201. All or some of operations performed in the electronic device 2201 may be performed in one or more of the other electronic devices 2202, 2204, and 2208. For example, when the electronic device 2201 needs to perform a function or service, the electronic device 2201 may request one or more other electronic devices to perform part or all function or service instead of executing the function or service itself. One or more other electronic devices receiving the request may execute an additional function or service related to the request, and transmit a result of the execution to the electronic device 2201. For this purpose, cloud computing, distributed computing, and/or client-server computing technologies may be used.

The OPA according to an example embodiment not only may use a phase modulator to modulate light for beamforming (optimization), but also may use a phase modulation optical amplifier (e.g., SOA).

Considering that phase modulation occurs due to a change in a refractive index as a current for optical amplification is applied to the phase modulation optical amplifier, currents of different magnitudes may be applied to a plurality of phase modulation optical amplifiers provided in the optical phased array according to an example embodiment in the beamforming. That is, the plurality of phase modulation optical amplifiers may have different optical amplification rates.

In this way, according to an example embodiment considering the phase modulation characteristics that appear in the operation of the phase modulation optical amplifier, the beamforming may be performed by applying amplification currents of different sizes to a plurality of phase modulation optical amplifiers, and thus, the beamforming efficiency and light intensity may be increased in a region of interest within a beam steering range compared to the related art OPA in which a current of the same magnitude is applied to all optical amplifiers.

While many matters have been described in detail in the above description, they should be construed as illustrative of embodiments rather than to limit the scope of the disclosure. Therefore, the scope of the disclosure should not be defined by the embodiments described above but should be determined by the technical spirit described in the claims.

It should be understood that example embodiments described herein should be considered in a descriptive sense only and not for purposes of limitation. Descriptions of features or aspects within each embodiment should typically be considered as available for other similar features or aspects in other embodiments. While one or more example embodiments have been described with reference to the figures, it will be understood by those of ordinary skill in the art that various changes in form and details may be made therein without departing from the spirit and scope as defined by the following claims and their equivalents.

What is claimed is:

1. An optical phased array comprising:
a light source configured to emit a light in an infrared band;
a light irradiator spaced apart from the light source and configured to receive the light emitted from the light source and irradiate the light to an outside;
a phase modulation optical amplification unit provided between the light source and the light irradiator; and
an optical splitting portion disposed between the light source and the phase modulation optical amplification unit and configured to split the light emitted from the light source, the optical splitting portion comprising a plurality of optical splitters,
wherein the phase modulation optical amplification unit is configured to amplify the light emitted from the light source while modulating a first phase of the emitted light to a second phase which is a target phase, and includes:
a phase modulator configured to cause a portion of a phase difference between the first phase and the second phase; and
a phase modulation optical amplifier configured to amplify the emitted light while causing a remaining portion of the phase difference.

2. The optical phased array of claim 1, wherein the phase modulator and the phase modulation optical amplifier are aligned in an order named in a direction from the light source to the light irradiator.

3. The optical phased array of claim 1, wherein the phase modulation optical amplifier and the phase modulator are aligned in an order named in a direction from the light source to the light irradiator.

4. The optical phased array of claim 1, wherein an optical amplifier is disposed between at least one optical splitter of the plurality of optical splitters and another at least one optical splitter of the plurality of optical splitters.

5. The optical phased array of claim 4, wherein the phase modulation optical amplification unit comprises a plurality of phase modulation optical amplification units spaced apart from each other, and
wherein one optical splitter among the plurality of optical splitters is arranged to split the light to be provided to two optical splitters in a next stage among the plurality of optical splitters.

6. The optical phased array of claim 4, wherein two to four optical amplifiers are disposed between a portion of the plurality of optical splitters and a remaining portion of the plurality of optical splitters.

7. The optical phased array of claim 1, wherein the phase modulation optical amplifier includes a semiconductor optical amplifier (SOA).

8. The optical phased array of claim 1, wherein the light source includes a laser diode configured to emit an infrared light and a semiconductor optical amplifier (SOA) configured to amplify the infrared light.

9. The optical phased array of claim 1, wherein the light irradiator, the phase modulation optical amplification unit, and the optical splitting portion are provided in one single chip, and
wherein the light source is coupled to the one single chip.

10. The optical phased array of claim 9, wherein the light source is bonded to the one single chip using a flip chip method.

11. The optical phased array of claim 1, wherein the phase modulation optical amplification unit comprises a plurality of phase modulation optical amplification units, and
wherein the plurality of phase modulation optical amplification units have different optical amplification rates from each other.

12. The optical phased array of claim 1, wherein the light irradiator includes an antenna array, the antenna array including a plurality of antenna elements or a mirror type emitting element.

13. A light detection and ranging (LiDAR) comprising:
a light source unit configured to emit a light toward an object, wherein the light source unit includes the optical phased array of claim 1;
a receiver configured to receive a light reflected from the object and generate an electrical signal in response to the received light;
a processor configured to process the electrical signal transmitted from the receiver; and
a controller configured to control an operation of the light source unit, the receiver, and/or the processor.

14. An electronic device comprising the optical phased array of claim 1.

15. A method of operating an optical phased array, wherein the optical phased array includes a plurality of phase modulation optical amplification units between a light source and a light irradiator, and the plurality of phase modulation optical amplification units include a plurality of phase modulators and a plurality of phase modulation optical amplifiers,
the method comprising performing a first beamforming on a first region of interest by applying currents of different magnitudes to the plurality of phase modulation optical amplifiers.

16. The method of claim 15, wherein during the first beamforming, a voltage applied to each of the plurality of phase modulators is maintained constant at a same level of magnitude.

17. The method of claim 15, further comprising: after performing the first beamforming, performing a second beamforming on the first region of interest by applying different voltages to the plurality of phase modulators.

18. The method of claim 17, further comprising: after beamforming for the first region of interest is completed, creating a lookup table for beam steering of the plurality of phase modulators and the plurality of phase modulation optical amplifiers based on the voltage data applied to the plurality of phase modulators and the current data applied to the plurality of phase modulation optical amplifiers for the beamforming for the first region of interest.

19. The method of claim 17, further comprising:
after performing the second beamforming, acquiring a beam image formed in the first region of interest by the first and second beamformings; and
acquiring a beam profile from the beam image.

20. The method of claim 19, wherein the acquiring comprises acquiring the beam image using an infrared camera provided outside an optical phased array chip on which the plurality of phase modulation optical amplification units are provided or a detector formed within the optical phased array chip.
